(19) United States
(12) Patent Application Publication
(10) Pub. No.: US 2003/0225652 A1
(43) Pub. Date: Dec. 4, 2003

(54) Method and computer program product for analyzing and projecting the future investment value of a business organization

(76) Inventors: Nell Minow, McLean, VA (US); Robert A.G. Monks, Palm Beach, FL (US); Ric Marshall, Cape Elizabeth, ME (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/156,760

(22) Filed: May 29, 2002

(51) Int. Cl. G06F 17/60

(52) U.S. Cl. 705/36

(57) ABSTRACT

A method and computer program product is provided for analyzing and projecting the future investment value of a business organization, such as a publicly-traded corporation. The method includes the assignment of a first score to the business organization based on one or more factors related to the corporate governance of the organization, including chief executive officer (CEO) compensation, outside director shareholdings, merger and acquisition (M&A) decisions, and accounting and audit practices. A second score is assigned to the business organization based on the past performance of the organization. The first and second scores are then correlated to provide a third score, which indicates a projected investment value of the business organization. The results may then be stored in a database and provided to an end user via a data network, such as the Internet, or stored on a computer useable medium, such as a floppy disk, CD-ROM or DVD-ROM.

### BACKGROUND OF THE INVENTION

1. Field of the Invention

The present invention is generally related to methods and computer program products for analyzing and rating business organizations.

2. Background

The past ten years have witnessed a growing awareness on the part of investors that the corporate governance structures and policies of publicly-traded companies can have an enormous impact on long-term shareholder value. Although extensive research has failed thus far to demonstrate any direct link between corporate governance and corporate performance, many experienced investors feel intuitively that good corporate governance adds a value premium to companies. For example, according to a recent Investor Opinion Survey conducted by McKinsey & Company, over 80% of 200 top institutional investors would pay an 18% or greater premium for shares in well-governed companies.

Many conventional methods for projecting the future investment value of a company do not take into account corporate governance factors, instead relying largely on data relating to a company's past performance. These projection methods are lacking because they ignore the impact that good or bad corporate governance can have on long-term shareholder value. For example, companies that have performed well in the past may nevertheless perform poorly in the future if they are poorly governed. Conversely, companies that have performed poorly in the past may nevertheless perform well in the future if they are well governed. Projection methods based on past performance alone cannot anticipate such trends.

Historically, corporate governance factors have been considered by firms that provide proxy voting recommendations to institutional investors. These firms analyze certain corporate governance policies, practices and decisions to ascertain their merits in anticipation of a proxy vote. Shareholder activist groups have also analyzed corporate governance factors to identify companies for which poor governance indicates the need for extraordinary shareholder concern and involvement. However, neither of the above-described analyses are directed at assessing the future investment value of a company.

Some existing firms do purport to provide a projection of future investment value relative to the corporate governance profiles of companies. However, these firms typically rely on methods that do not take into account the past performance of a company, but instead focus on corporate governance factors alone. Moreover, these firms typically use a simple “benchmarking” approach for rating companies, whereby the company is assessed in accordance with an extensive checklist of traditional corporate governance indicators, some of which are not as important as others in terms of their impact on long-term shareholder value. However, because all of the indicators generally receive equal weight, benchmarking yields a score that has its own internal logic relative to corporate governance but bears no real relation to the future investment value of a company.

What is desired then is a method and computer program product for analyzing and projecting the future investment value of a company that takes into account corporate governance factors as well as data relating to the past performance of the company. By correlating corporate governance factors with past performance, the desired method and computer program product should generate a projection of the future investment value of the company, including whether the company is likely to sustain or improve value, the index potential of the company's stock, and an assessment of the risk of investing in the company. The desired method and computer program product should also focus only on a limited set of key corporate governance factors that most directly bear on the future investment value of the company. Finally, the results of the desired method and computer program product should be stored so that they are easily accessible to an end-user via a variety of access methods.

### BRIEF SUMMARY OF THE INVENTION

Embodiments of the present invention provide a rating system that defines the connection between corporate governance and shareholder value. The rating system includes a rigorous methodology that identifies and quantifies certain key indicators of the effectiveness of the board of directors of a company. The rating system then projects future market performance by correlating past performance of the company against current board effectiveness, effectively identifying previously hidden trends of investment value and risk.

Because the rating system takes into account corporate governance factors as well as past performance, it provides an analysis that looks beyond the balance sheet and effectively gauges the likely future impact of a company's corporate governance practices on company share performance. The rating system is premised on the observation that well-governed companies that are performing well, and poorly governed companies that are performing poorly, will be more likely to continue those patterns, and conversely, that poorly governed companies that are performing well, and well governed companies that are performing poorly, will be less likely to continue those patterns.

A methodology in accordance with the present invention focuses on those dynamic aspects of corporate governance that directly impact shareholder value, and, as such, provides a major advance over conventional proxy voting analysis and social screening methodologies. For example, a methodology in accordance with the present invention focuses on key areas over which the board of directors of a company exercises control and where board oversight is most crucial. These areas include:

Chief Executive Officer (CEO) Compensation: CEO compensation is analyzed to determine if CEO pay is tied to value creation and if the CEO is held accountable to shareholders, the market and the board of directors itself;

Outside director shareholdings: Outside director shareholdings are analyzed to determine if outside directors have a vested interest in the long-term success of the company;

Mergers and Acquisition (M & A) Decisions: The M & A decisions of the board of directors are analyzed to determine if the board approved purchases that truly add value or, for example, were prompted more by CEO empire-building; and

Accounting and Audit Practices: The accounting and audit practices of the company are analyzed to determine if the board of directors has signed off on practices and policies that provide the most accurate picture of the company's health and value.

In an embodiment of the present invention, data is drawn from publicly-available sources such as SEC filings, news stories and company releases to generate ratings for board effectiveness. These ratings are then correlated with data related to the past performance of the company to generate a score indicating a projected future investment value for the company. Ratings generated in accordance with an embodiment of the present invention may be used by investors, portfolio managers and analysts to make investment decisions, to build benchmarks for well-governed companies to enhance access to capital, or to identify poorly performing companies that are susceptible to shareholder action.

In particular, as will be described in more detail herein, the present invention provides a method for projecting the future investment value of a business organization and presenting the results to a user. In accordance with an embodiment of the invention, the method includes collecting data about a business organization, analyzing the data and projecting the future investment value of the business organization therefrom, and storing the results in a database. The contents of the database may then be provided to a user via a data network, such as the Internet, or stored on a computer useable medium, such as a floppy disk, CD-ROM or DVD-ROM, and provided to a user on the computer useable medium.

Projecting the future investment value of a business organization in accordance with an embodiment of the present invention includes assigning a first score to the business organization based on one or more of the following factors related to corporate governance: chief executive officer compensation, outside director shareholdings, merger and acquisition decisions, and accounting and audit practices. The method also includes assigning a second score to the business organization based on past performance of the business organization. The second score may be based, for example, on the difference between a return on investment in the business organization and an industry average return on investment. The method further includes assigning a third score to the company by correlating the first score to the second score, wherein the third score indicates a projected investment value of the business organization.

A computer program product in accordance with an embodiment of the present invention includes a computer useable medium having computer program logic recorded thereon for enabling a processor in a computer system to project the future investment value of a business organization. The computer program logic includes first means for enabling the processor to assign a first score to the business organization based on one or more of the following factors related to corporate governance: chief executive officer compensation, outside director shareholdings, merger and acquisition decisions, and accounting and audit practices. The computer program logic also includes second means for enabling the processor to assign a second score to the business organization based on the past performance of the business organization. The second score may be based, for example, on the difference between a return on investment in the business organization and an industry average return on investment. The computer program logic further includes third means for enabling the processor to assign a third score to the company by correlating the first score to the second score, wherein the third score indicates a projected investment value of the business organization. In an embodiment of the invention, the computer program logic further includes fourth means for enabling the processor to store the third score in a database.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 is a flowchart of a method for analyzing and projecting the future investment value of a company and presenting the results to a user in accordance with an embodiment of the present invention.

FIG. 2 is a flowchart of a method of analyzing and projecting the future investment value of a company in accordance with an embodiment of the present invention.

FIG. 3 is a flowchart of a method for assigning a score to a company based on factors related to corporate governance.

FIG. 4 illustrates an example computer system for analyzing company data and projecting future investment value therefrom in accordance with embodiments of the present invention.

FIG. 5 is a block diagram of an example network environment for delivering the results of a method for analyzing company data and projecting future investment value therefrom in accordance with an embodiment of the present invention.

FIGS. 6 and 7 illustrate example user interfaces for presenting the results of a method for analyzing company data and projecting future investment value therefrom in accordance with an embodiment of the present invention.

The features and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF THE INVENTION

A. Overview

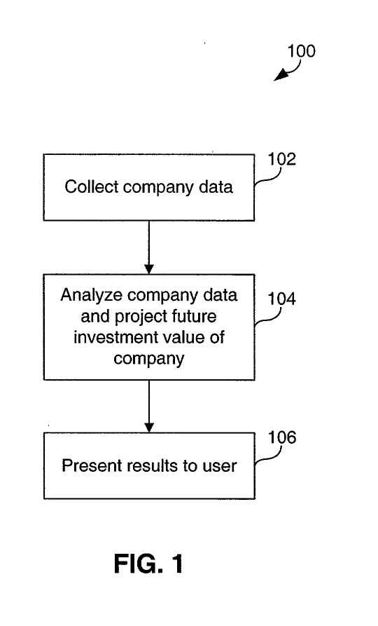

FIG. 1 depicts a flowchart 100 of a method for analyzing and projecting the future investment value of a business organization and presenting the results to a user in accordance with an embodiment of the present invention. In the embodiments described herein, the business organization comprises a publicly-traded company. As shown in FIG. 1, the method includes three main steps: (1) collecting data related to the company at step 102; (2) analyzing the collected data and projecting the future investment value of the company therefrom at step 104; and finally (3) presenting the results of the analysis and projection to a user at step 106. The invention, however, is not limited to the description provided by the flowchart 100. Rather, it will be apparent to persons skilled in the relevant art(s) from the teachings provided herein that other functional flows are within the scope and spirit of the present invention.

The collection of company data at step 102 involves the collection of data relating to both corporate governance of the company as well as to the past performance of the company. For example, in an embodiment of the invention, step 102 involves the collection of data relating to chief executive officer (CEO) compensation, outside director shareholdings in the company, merger and acquisition (M&A) decisions made by the board of directors of the company, the accounting and audit practices of the company, and other miscellaneous factors bearing on corporate governance, as well as data relating to past performance of the company, such as an annual return on investment in the company over some predefined period (e.g., one year). Such information may be gathered from public filings with the Securities and Exchange Commission (SEC), news stories, company press releases, and other readily accessible public sources.

At step 104, the data collected in step 102 is analyzed and, based on the analysis, the future investment value of the company is projected. In accordance with embodiments of the present invention, the analysis includes assigning a first score to the company based on corporate governance factors, assigning a second score to the company based on past performance of the company, and then correlating the first and second score to generate a third score, wherein the third score indicates a projected future investment value for the company. As will be discussed in more detail herein, various aspects of step 104 may be performed in whole or in part by a computer system, including but not limited to a standard personal computer (PC).

At step 106, the results of the analysis and projection of step 102 are presented to an end-user. In an embodiment of the invention, analysis and projection results for a plurality of companies are stored in a database, which is then made available to the end-user. For example, the database may be made available to the end-user via a data network, such as the Internet. Alternately, the database is stored on a computer useable medium, such as a floppy disk or CD-ROM, and the end-user accesses it by loading the medium into a computer system, such as a standard personal computer. However, these examples are not intended to be limiting, and a variety of methods may be used to communicate the results of the analysis and projection step 102 to an end-user.

B. Analyzing and Project Future Investment Value of a Company

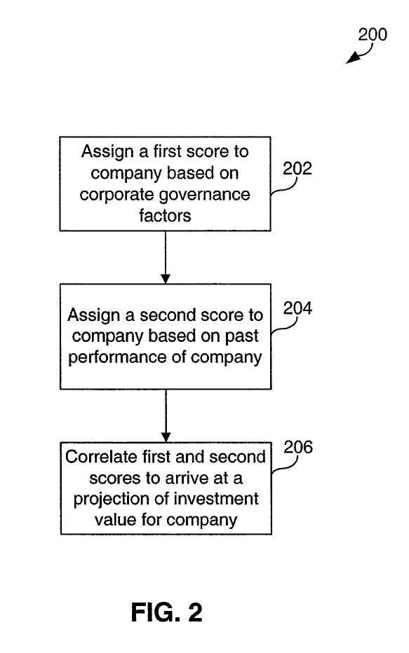

FIG. 2 depicts a flowchart 200 of a method of analyzing and projecting the future investment value of a company in accordance with an embodiment of the present invention. The flowchart 200 provides an example of one method for performing step 104 of flowchart 100, which is described above in reference to FIG. 1. As shown in FIG. 2, the method includes a first step 202, in which a first score is assigned to a company based on corporate governance factors, a second step 204, in which a second score is assigned to the company based on the past performance of the company, and a third step 206, in which the first and second scores are correlated to arrive at a projection of future investment value for the company. Each of these steps will now be described in more detail.

1. Score Assignment Based on Corporate Governance Factors

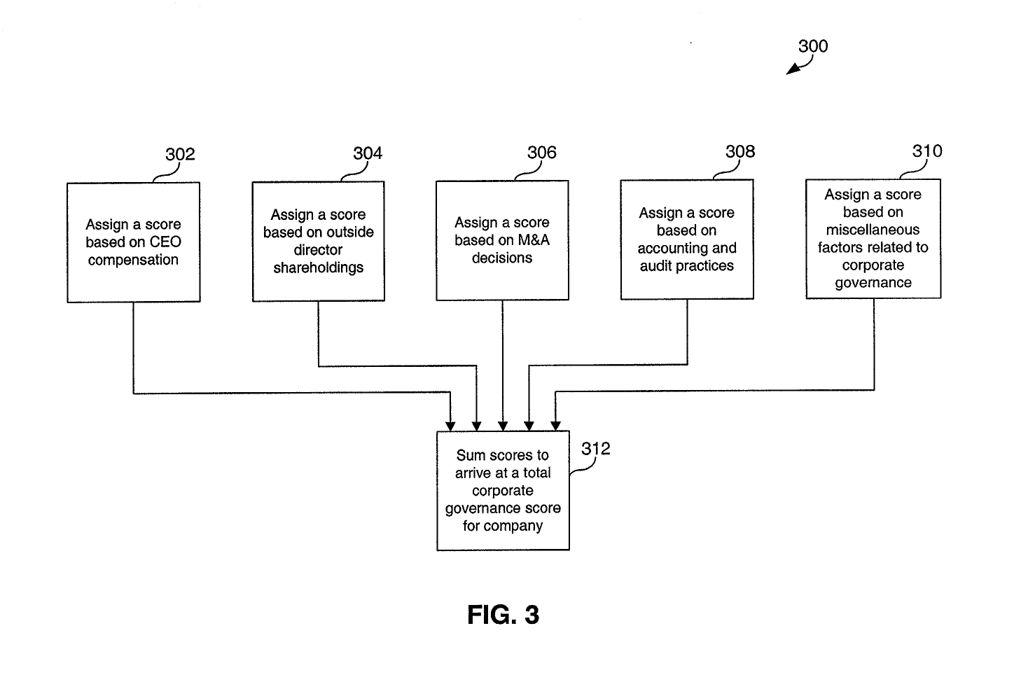

FIG. 3 depicts a flowchart 300 of a method for assigning a score to a company, or a board of directors of a company, based on factors related to corporate governance. The invention, however, is not limited to the description provided by the flowchart 300. Rather, it will be apparent to persons skilled in the art from the teachings provided herein that other functional flows are within the scope and spirit of the present invention. For example, the present invention encompasses the performance of additional steps or fewer steps than those shown in flowchart 300.

As illustrated in flowchart 300, the method includes assigning several scores to a company based on key factors relating to corporate governance, which are then summed to arrive at a total overall corporate governance score for the company. In accordance with an embodiment of the present invention, the key factors comprise factors that have been observed to relate strongly to the quality of governance for the company and to have an impact on long-term shareholder value. Preferably, the key factors do not relate to past performance of the company.

The scoring steps of flowchart 300 include steps 302, 304, 306, 308 and 310. In step 302, a first score is assigned to a company based on the company's policies and practices in regard to chief executive officer (CEO) compensation. In step 304, a second score is assigned to the company based on the size of outside director shareholdings. In step 306, a third score is assigned to the company based on merger and acquisition (M&A) decisions made by the board of directors of the company. In step 308, a fourth score is assigned to the company based on the company's accounting and audit practices. In step 310, a fifth score is assigned to the company based on miscellaneous indicators or problems relating to corporate governance. Finally, in step 312, the scores from each of steps 302, 304, 306, 308 and 310 are summed to generate an overall corporate governance score for the company.

The scoring steps may be performed in any order, or in parallel. In an embodiment, two or more of the scoring steps are performed in a serial manner. In another embodiment, at least one of the scoring steps is performed in parallel with at least one of the other scoring steps. Each of the above-described scoring steps will now be explained in more detail.

a. CEO Compensation

In accordance with an embodiment of the present invention, a score is assigned to each company based on the practices and policies of each company relating to CEO compensation. Generally speaking, this scoring step is based on the principle that a CEO compensation scheme that ties compensation to value creation and holds the CEO accountable to shareholders, the market and the board of directors itself, will generally result in improved corporate governance.

To arrive at a score, various elements of CEO compensation may be analyzed including regular compensation, incentive-based compensation, as well as short-term and long-term compensation. In this regard, data may be reviewed relating to a company's CEO compensation policies, incentive-based compensation for the CEO, CEO shareholding, and CEO contracts, employment agreements, and severance arrangements with the company. In an embodiment of the invention, a high score is assigned where the CEO compensation practices and policies of a company will be likely to encourage good corporate governance, a low score is assigned where the CEO compensation scheme is unlikely to encourage good corporate governance, and a neutral score is assigned where, on the whole, the CEO compensation scheme is neither likely or unlikely to encourage good corporate governance.

b. Outside Director Shareholdings

In accordance with an embodiment of the present invention, a score is assigned to each company based on the amount of shares in the company owned by outside directors (i.e., non-executives) on the board of directors. This scoring step is based on the principle that large shareholdings by outside directors correlate to improved corporate governance.

For example, in an embodiment, three possible scores are assigned to a board based on outside director shareholdings: (a) a low score is assigned where a majority of outside directors do not hold a minimum number of shares in the company; (b) a neutral score is assigned where a majority of outside directors hold a minimum number of shares in the company; or (c) a high score is assigned where all the outside directors hold a minimum number of shares in the company. The minimum number of shares is preferably the number of shares associated with a predetermined share value. For example, in an embodiment, the minimum number of shares is the number of shares corresponding to a share value of $200,000.

In an embodiment, this step is performed by calculating the approximate current dollar value of shares held by each director, and then by determining how many of the outside directors on the board own shares having a value greater than a predetermined share value. The algorithm allows for the addition of new directors by adjusting for tenure.

c. Merger and Acquisition Decisions

In accordance with an embodiment of the present invention, a score is assigned to each company based on the quality of past merger and acquisition (M&A) decisions made by the company's board of directors, as determined by the impact of those decisions on shareholder value.

For example, in an embodiment, three possible scores are assigned to a board based on M&A decisions: (a) a low score is assigned where a large loss in shareholder value has resulted from past M&A decisions by the board; (b) a neutral score is assigned where a past M&A decisions by the board have had a minimal impact on shareholder value; or (c) a high score is assigned where past M&A decisions by the board has resulted in strong gains in shareholder value.

d. Accounting and Audit Practices

In accordance with an embodiment of the present invention, a score is assigned to each company based on the accounting and audit practices approved by the board of directors of the company. Generally speaking, poor or suspect accounting and audit practices will result in a lower score.

For example, in an embodiment, a scoring penalty is cumulatively applied to a company based on the presence of certain accounting and audit indicators. A larger penalty is incurred for each of the following indicators: (a) known instances of fraud or misrepresentation; (b) repetitive large special charges, i.e., expenses which a company recognizes in a single reporting period, and which the company claims is unlikely to recur in the future; and (c) reliance on “cookiejar” reserves, a corporate accounting practice of taking reserves against losses during profitable years and using them in unprofitable years to smooth out earnings numbers and make a company's operations seem more consistent than they are. A smaller penalty is incurred for each of the following indicators: (a) pension gains or options-related tax gains added to operational earnings; (b) any other reporting of non-GAAP (Generally Accepted Accounting Principles) operational earnings; (c) qualified opinions by auditors, i.e., opinions for which some limitations exist, such as an inability to gather certain information or a significant upcoming event which may or may not occur; and (d) auditors who make more for non-audit services.

In an embodiment, this step is performed by assigning a negative score or penalty to a company for each of the above indicators, and then accumulating the penalties to generate an overall score for the company relating to accounting and audit practices. A score of zero would thus indicate no problems in this area.

e. Miscellaneous Problems

In accordance with an embodiment of the present invention, a score is assigned to each company based on a variety of other corporate governance indicators that do not fall within the categories of CEO compensation, outside director shareholdings, M&A decisions, and accounting and audit practices, as described above.

For example, in an embodiment, a scoring penalty is cumulatively applied to a board based on indications of certain miscellaneous problems. A larger penalty may be incurred for each of the following indicators: (a) indexed stock; or (b) three or more token directors, wherein a token director includes sitting or retired CEOs, politicians, celebrities, academic or minority directors who sit on five or more boards. A smaller penalty is incurred for each of the following indicators: (a) exiting CEO remains as chairman, which indicates a lack of confidence in the new CEO; (b) a homologous board (i.e., a board with all directors from the same industry or geographical region); (c) the company is listed on one of the focus lists of underperforming corporations published by the California Public Employees' Retirement System (CalPERS), the Council of Institutional Investors (CII), or other known shareholder activists; (d) the company has paid significant fines or penalties for criminal or negligent behavior in the last three years; (e) large recent insider stock sales (e.g., within the past six months); and (f) lack of board focus on core business.

In an embodiment, this step is performed by assigning a negative score or penalty to a company for each of the above indicators, and then accumulating the penalties to generate an overall score for the company relating to miscellaneous problems. A score of zero would thus indicate no problems in this area.

f. Sample Scoring Breakdown

Table 1, below, illustrates an example scoring system for assigning a score to a company, or board of directors of a company, based on key corporate governance factors.

TABLE 1

| | | | |
|---|---|---|---|
| CEO Compensation | TOTAL RANGE THIS CATEGORY | | −30 to 30 |
| Outside Director Shares | TOTAL RANGE THIS CATEGORY | | −50 to 50 |
| | All outside directors hold minimum number of shares | 50 | |
| | Majority of outside directors hold minimum number of | 0 | |
| | shares | | |
| | Majority of outside directors do not hold minimum number | −50 | |
| | of shares | | |
| M&A Decisions | TOTAL RANGE THIS CATEGORY | | −20 to 20 |
| | Storng value gains due to M&A decisions | 20 | |
| | M&A decisions have had minimal impact on shareholder | 0 | |
| | value | | |
| | Large value losses due to M&A decisions | −20 | |
| Accounting Practices | TOTAL RANGE THIS CATEGORY | | −50 to 0 |
| | Known instances of fraud or misrepresentation | −10 | |
| | Repetitive large special charges | −10 | |
| | Reliance on “cookie jar” reserves | −10 | |
| | Pension gains or options-related tax gains added to | −5 | |
| | operational earnings | | |
| | Any other reporting of non-GAAP operational earnings | −5 | |
| | Qualified opinions by auditors | −5 | |
| | Auditors make more for non-audit services | −5 | |
| Miscellaneous Problems | TOTAL RANGE THIS CATEGORY | | −50 to 0 |
| | Indexed stock | −10 | |
| | 3 or more celebrity or token directors | −10 | |
| | Exiting CEO remains as chairman | −5 | |
| | Homologous board | −5 | |
| | Is on shareholder activist focus list | −5 | |
| | Has paid significant fines or penalties for criminal or | −5 | |
| | negligent behavior in last 3 years | | |
| | Large recent insider stock sales | −5 | |
| | Lacks focus on core business | −5 | |
| TOTAL RANGE | | | −200 to 100 |

In accordance with the scoring system illustrated in Table 1, a company receives separate scores in each of the five categories of CEO compensation, outside director shares, M&A decisions, accounting practices, and miscellaneous problems. These scores are then summed to generate an overall governance score for the company.

The total number of points attributed to each category determines the weight given to that category in obtaining the overall corporate governance score. For example, in the scoring system illustrated in Table 1, the CEO compensation category accounts for 60 points of the total 300 point range, and therefore represents 20% of the total score. In further accordance with the scoring system illustrated in Table 1, the outside director shares category accounts for approximately 33.3% of the total score, the M&A decisions category accounts for approximately 13.3% of the total score, and the accounting practices and miscellaneous problems categories each account for approximately 16.7% of the total score. As will be appreciated by persons skilled in the relevant art, the weight given to each category in this scheme may be modified as desired by changing the number of points allocated to each category.

The total range of scores for the system illustrated in Table 1 is −200 to 100 points. In accordance with an embodiment of the present invention, a total score within the range of 40 to 100 corresponds to a “strong” governance rating for the company, a total score within the range of −40 to 39 corresponds to an “average” governance rating for the company, and a total score within the range of −200 to −41 corresponds to a “poor” governance rating for the company.

2. Score Assignment Based on Past Company Performance

As discussed above in reference to flowchart 200 of FIG. 2, in a second step 204 of a method of analyzing and projecting the future investment value of a company in accordance with an embodiment of the present invention, a second score is assigned to a company based on the past performance of the company. Past company performance may be gauged by comparing return on investment in the company with industry average returns. For example, in an embodiment of the invention, one year returns for the company are compared to industry average one year returns. Where returns are ten points or better than industry average 1 year returns, a score indicative of a “strong” performance rating is assigned to the company. Where returns are between nine points below or above industry average 1 year returns, a score indicative of an “average” performance rating is assigned to the company. Where returns are 10 points or more below industry average 1 year returns, a score indicative of a “poor” performance rating is assigned to the company.

3. Correlation of Board Scores to Past Company Performance

As also discussed above in reference to flowchart 200 of FIG. 2, in a third step 206 of a method of analyzing and projecting the future investment value of a company in accordance with an embodiment of the present invention, the corporate governance score from the first step 202 is correlated with the performance score from the second step 204 to arrive at a projection of investment value for the company.

Board scores may be correlated with performance scores in the manner illustrated in Table 2, below, to arrive at overall, forward-looking, investment and risk-oriented letter grades:

TABLE 2

| Per- | | | | | Risk |
|---|---|---|---|---|---|
| form- | | | Investment | | Assess- |
| ance | Board | Grade | Category | Index Potential | ment |
| Strong | Strong | A | Likely to | Sustainable | Lowest |
| | | | Sustain Value | Out- | Risk |
| | | | | Performance | |
| Average | Strong | B | Likely to | Value Stocks- | Low |
| | | | Improve Value | Average Gains | Risk |
| Poor | Strong | B | Likely to | Value Stocks- | Low |
| | | | Improve Value | Highest Gains | Risk |
| Strong | Average | C | Neutral Impact | None | Average |
| | | | on Value | | Risk |
| Average | Average | C | Neutral Impact | None | Average |
| | | | on Value | | Risk |
| Poor | Average | C | Neutral Impact | None | Average |
| | | | on Value | | Risk |
| Strong | Poor | D | Unlikely to | Short stocks- | High |
| | | | Sustain Value | Highest Gains | Risk |
| Average | Poor | D | Unlikely to | Short stocks- | High |
| | | | Improve Value | Average gains | Risk |
| Poor | Poor | F | Unlikely to | May be | Highest |
| | | | Improve Value | susceptible to | Risk |
| | | | | shareholder | |
| | | | | action | |

The correlation scheme of Table 2 assumes that the resulting corporate governance score for each company from step 202 corresponds to one of three overall ratings, “strong,” “average,” or “poor,” and that each company is also assigned a similar rating based on the performance score from step 204. These two ratings are then plotted using Table 2 to determine a letter grade for each company, which in turn implies a certain investment projection and overall investment risk assessment.

The correlation scheme of Table 2 generates a projection of future investment value of a company, including an assessment of whether the company is likely to sustain or improve value, the index potential of the company's stock, and an assessment of the risk of investing in the company. The correlation scheme is based on the underlying principle that well-governed companies that are performing well, and poorly governed companies that are performing poorly, will be more likely to continue those patterns, and conversely, that poorly governed companies that are performing well, and well governed companies that are performing poorly, will be less likely to continue those patterns.

4. Example Computer Implementation in Accordance with Embodiments of the Present Invention

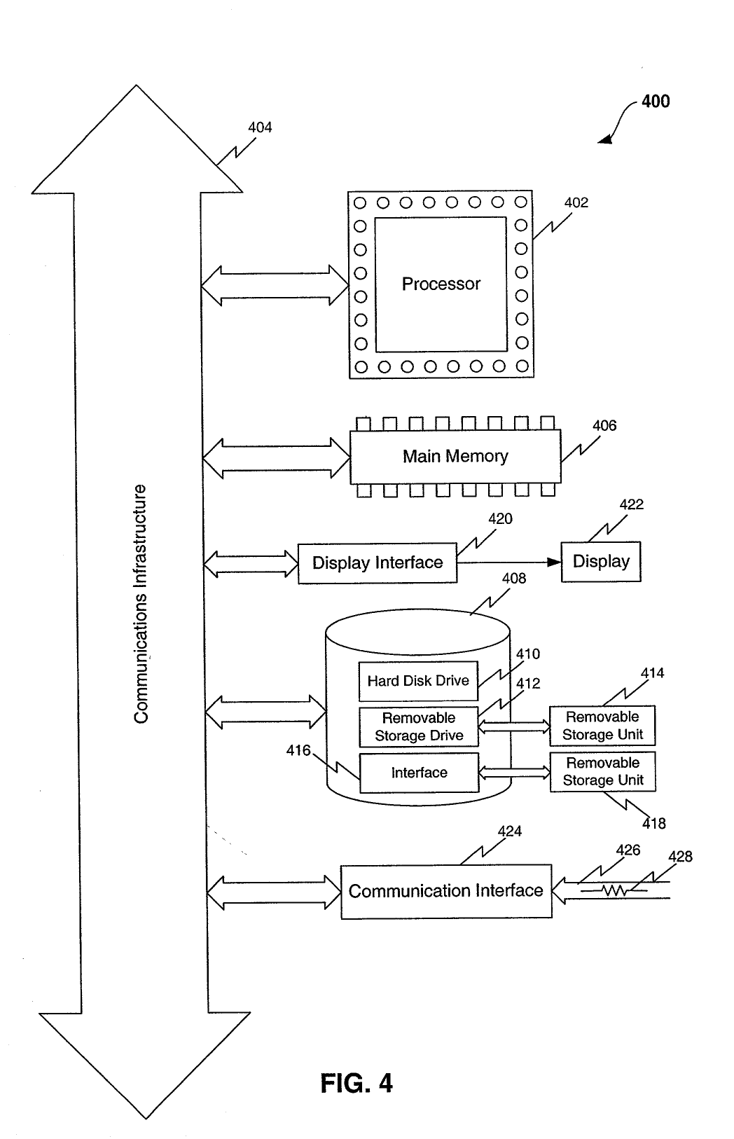

Methods for analyzing company data and projecting future investment value therefrom in accordance with embodiments of the present invention may be implemented in software and executed by one or more computer systems or other processing systems. For example, FIG. 4 depicts an example computer system 400 that may execute software for implementing the methods of the present invention, including, but not limited to, any or all of the method steps of flowcharts 200 and 300 described above in reference to FIGS. 2 and 3, respectively.

As shown in FIG. 4, the example computer system 400 includes a processor 402 for executing software routines in accordance with embodiments of the present invention. Although a single processor is shown for the sake of clarity, the computer system 400 may also comprise a multi-processor system. The processor 402 is connected to a communication infrastructure 404 for communication with other components of the computer system 400. The communication infrastructure 404 may comprise, for example, a communications bus, cross-bar, or network.

Computer system 400 further includes a main memory 406, such as a random access memory (RAM), and a secondary memory 408. The secondary memory 408 may include, for example, a hard disk drive 410 and/or a removable storage drive 412, which may comprise a floppy disk drive, a magnetic tape drive, an optical disk drive, or the like. The removable storage drive 412 reads from and/or writes to a removable storage unit 414 in a well known manner. Removable storage unit 414 may comprise a floppy disk, magnetic tape, optical disk, or the like, which is read by and written to by removable storage drive 412. As will be appreciated by persons skilled in the art, the removable storage unit 414 includes a computer usable storage medium having stored therein computer software and/or data.

In alternative embodiments, secondary memory 408 may include other similar means for allowing computer programs or other instructions to be loaded into computer system 400. Such means can include, for example, a removable storage unit 418 and an interface 416. Examples of a removable storage unit 418 and interface 416 include a program cartridge and cartridge interface (such as that found in video game console devices), a removable memory chip (such as an EPROM, or PROM) and associated socket, and other removable storage units 418 and interfaces 416 which allow software and data to be transferred from the removable storage unit 418 to computer system 400.

Computer system 400 further includes a display interface 420 that forwards graphics, text, and other data from the communication infrastructure 404 or from a frame buffer (not shown) for display to a user on a display unit 422.

Computer system 400 also includes a communication interface 424. Communication interface 424 allows software and data to be transferred between computer system 400 and external devices via a communication path 426. Examples of communications interface 424 can include a modem, a network interface (such as Ethernet card), a communications port, and the like. Software and data transferred via communications interface 424 are in the form of signals 428 which can be electronic, electromagnetic, optical or other signals capable of being received by communications interface 424. These signals 428 are provided to the communications interface via the communication path 426.

As used herein, the term “computer program product” may refer, in part, to removable storage unit 414, removable storage unit 418, a hard disk installed in hard disk drive 410, or a carrier wave carrying software over a communication path 426 (wireless link or cable) to communication interface 424. A computer useable medium can include magnetic media, optical media, or other recordable media, or media that transmits a carrier wave or other signal. These computer program products are means for providing software to computer system 400.

Computer programs (also called computer control logic) are stored in main memory 406 and/or secondary memory 408. Computer programs can also be received via communications interface 424 Such computer programs, when executed, enable the computer system 400 to perform the features of the present invention as discussed herein.

In particular, the computer programs, when executed, enable the processor 402 to perform the method steps of flowchart 200 as described above in reference to FIG. 2, wherein necessary inputs such as information relating to corporate governance and corporate performance are provided by a user via a user input device (not shown), or are obtained from main memory 406, secondary memory 408, or communication interface 424. The computer programs, when executed, may also enable the processor 402 to perform the method steps of flowchart 300 as described above in reference to FIG. 3, wherein necessary inputs such as scores relating to key corporate governance factors are provided by a user via a user input device (not shown), or are obtained from main memory 406, secondary memory 408, or communication interface 424. Accordingly, such computer programs represent controllers of the computer system 400.

In an embodiment where the present invention is implemented using software, the software may be stored in a computer program product and loaded into computer system 400 using removable storage drive 412, hard disk drive 4120 or communication interface 425. Alternatively, the computer program product may be downloaded to computer system 400 over communications path 426. The software, when executed by the processor 402, causes the processor 402 to perform functions of the invention as described herein.

C. Presentation of Projection Results

In accordance with an embodiment of the present invention, the results of the above-described method for analyzing company data and projecting future investment value therefrom are stored in a database for presentation to an end-user. For example, with continued reference to the exemplary computer system 400, a computer program, when executed, enables the processor 402 to store projection results in a database residing in main memory 406 or secondary memory 408. The information in the database is then made available to an end-user.

1. Network Access

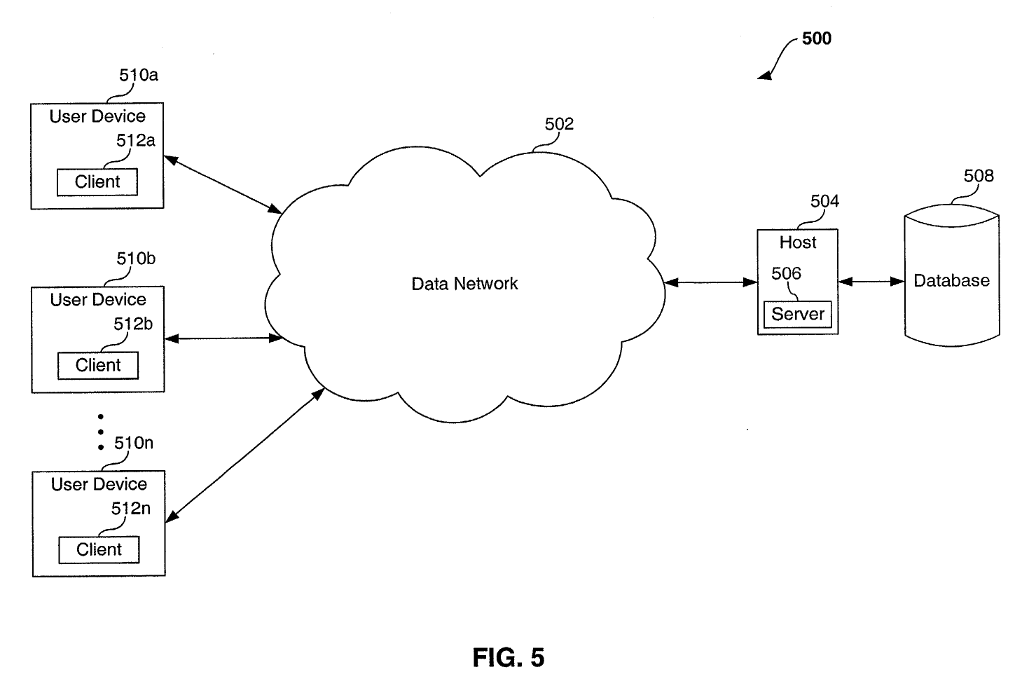

For example, in an embodiment, the database is made available to an end-user via a data network. FIG. 5 is a block diagram of an example network environment 500 for results delivery in accordance with embodiments of the present invention. The example network environment 500 includes a data network 502 which connects a plurality of user devices 510a-510n to a host 504. The data network 502 provides a pathway for the bi-directional communication of electronic data between the user devices and the host. The data network 502 can comprise any type of computer network or combination of networks including, but not limited to, circuit switched and/or packet switched networks. Additionally, the data network 502 may comprise a variety of transmission mediums including, but not limited to, twisted pair, coaxial cable, fiber-optic and/or wireless transmission mediums. In an example environment, the data network 502 includes a wide area network such as the Internet.

Each user device 510a-510n executes a corresponding client application 512a-512n that is adapted to generate and transmit requests for electronic information to the host 504. Each client 512a-512n is further adapted to receive responses as well as requested data from the host 504. For example, in accordance with an embodiment of the present invention, each client 512a-512n is adapted to request and receive the results of the above-described method for analyzing company data and projecting future investment value therefrom from the host 504.

In an example environment, each user device 510a-510n comprises a personal computer and each client 512a-512n comprises a commercially-available Web browser for requesting and receiving electronic information over the data network 502. However, this example is not limiting and each user device 510a-510n can comprise any device capable of running client applications for sending and receiving electronic information over a data network including, but not limited to, data terminal equipment, set-top boxes, Personal Digital Assistants (PDAs), cellular phones, automotive on-board computers, and the like.

The host 504 executes a server program 506 that is adapted to respond to client requests and provide requested data. In accordance with an embodiment of the present invention, the server program 506 responds to client requests for the results of the above-described method for analyzing company data and projecting future investment value therefrom by transmitting those results via the data network 502 to the requesting user device. In an example environment, the host 504 comprises an Intel processor-based computer system running a Microsoft Windows or Linux operating system.

As shown in FIG. 5, the host 504 is coupled to a storage device 508 for storing electronic information that may be requested by one or more clients. The storage device 508 may each comprise a memory that is internal to the host, including but not limited to a random-access memory (RAM) or a hard disk, or a memory device that is external to the host, including but not limited to an attached file server, one or more disk arrays, or a storage area network (SAN). In accordance with an embodiment of the present invention, the storage device 508 stores a database of the results of the above-described method for analyzing company data and projecting future investment value therefrom, so that the server 506 may provide such results to in response to client requests.

A variety of conventional communication protocols can be used to support communication between the clients 512a-512n and the server 506. In an example operating environment, a Transmission Control Protocol/Internet Protocol (TCP/IP) suite is used to establish links and transport data, while a Hypertext Transfer Protocol (HTTP) or File Transfer Protocol (FTP) application layer is used for client-server communication. However, these examples are illustrative. Results delivery in accordance with the present invention is not intended to be limited to a specific communication protocol or application, and other proprietary or non-proprietary network communication protocols and applications can be used.

2. Computer Useable Medium

In an alternate embodiment, the database is stored on a computer useable medium, such as a floppy disk, CD-ROM, DVD-ROM, or other magnetic or optical media, and is loaded by an end user into a computer system, such as the exemplary computer system 400 described above in reference to FIG. 4. The end user may then use the computer system to access the results from the database using one or more standard or proprietary database access programs, as will be appreciated by those skilled in the relevant art(s).

3. Example User Interface

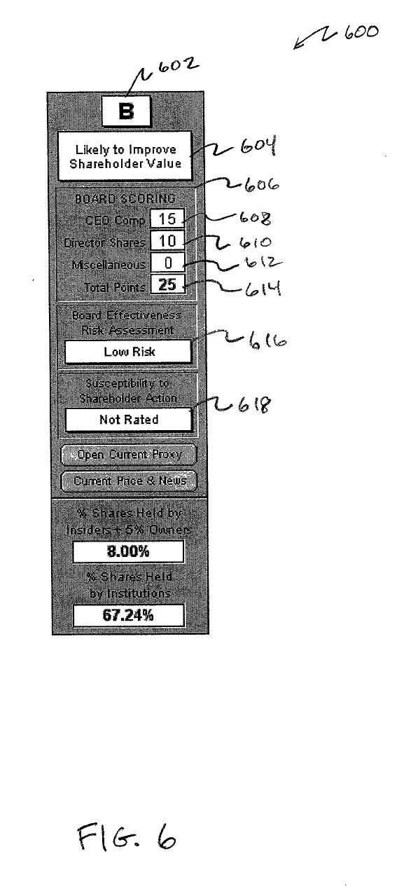

FIG. 6 illustrates an example user interface 600 for presenting the results of the above-described method for analyzing company data and projecting future investment value therefrom in accordance with an embodiment of the present invention. As discussed above, in an embodiment of the present invention, results are presented via a data network, such as via the Internet. In accordance with such an embodiment, the user interface 600 may comprise part of a Web page that is accessed by an end user using a commercially-available Web browser. As also discussed above, in an alternate embodiment of the present invention, results are stored in a database on a computer useable medium, such as a floppy disk, CD-ROM, DVD-ROM or other magnetic or optical media, and are accessed by an end user using a computer, such as a standard personal computer. In accordance with such an embodiment, the user interface 600 may comprise part of proprietary database access software that is used to access the database stored on the computer useable medium.

As shown in FIG. 6, the example user interface 600 includes a letter grade section 602 that reports a letter grade relating to the future investment value of the company, and a section 604 that explains the meaning of the letter grade reported in section 602. In an embodiment, these fields correspond to the grades and investment categories set forth in Table 2, above.

The example user interface 600 also includes a board scoring section 606 that displays the scores assigned to the company's board of directors in the areas of CEO compensation 608, outside director shareholdings 610, and miscellaneous factors relating to corporate governance 612, as well as a total sum of those scores 614. In an embodiment, these scores are assigned based on factors related to corporate governance in accordance with a methodology similar to that presented in reference to flowchart 300, above, except that the methodology does not take into account merger and acquisition decisions or accounting and audit practices. Such a methodology, however, is also within the scope of the present invention.

The example user interface 600 further includes a board effectiveness risk assessment section 616 and a susceptibility to shareholder action section 618. The board effectiveness risk assessment section 616 is used to present a risk assessment of investing in the company. In an embodiment, this field corresponds to the risk assessment categories set forth in Table 2 above. The susceptibility to shareholder action section 618 is used to rate whether or not the company may be susceptible to a shareholder action based on corporate governance and past performance factors.

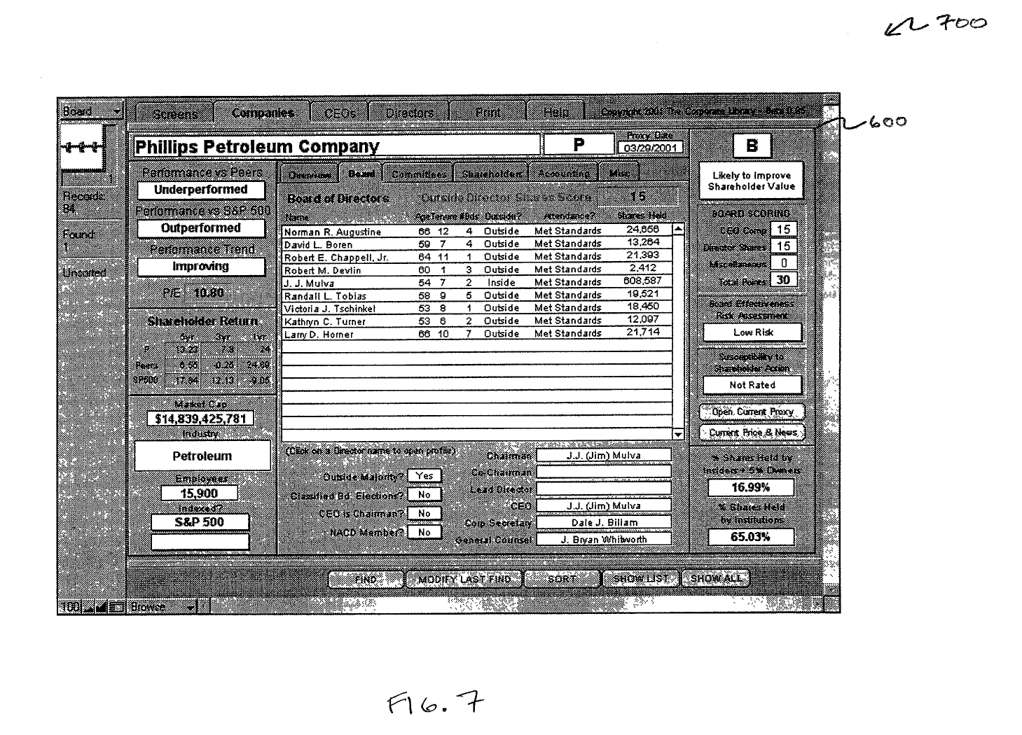

In an embodiment of the present invention, the user interface 600 is incorporated into a larger user interface that contains other additional information about the company. For example, FIG. 7 illustrates a user interface 700 that incorporates the user interface 600 and also presents other information about a company, such as information about the company's past performance, board of directors, CEOs, committees, shareholders, accounting, and the like. Please note that the example user interfaces 600 and 700 have been presented herein merely by way of example and are not intended to limit the manner in which results are presented to an end user in accordance with an embodiment of the present invention. Numerous interface types and designs may be used to present the results of the above-described method for analyzing company data and projecting future investment value therefrom, as will be appreciated by persons skilled in the relevant art(s) from the teachings provided herein.

D. Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computer program product comprising a computer useable medium having computer program logic recorded thereon for enabling a processor in a computer system to project the future investment value of a business organization, said computer program logic comprising:
first means for enabling the processor to assign a first score to the business organization based on the corporate governance of the business organization;
second means for enabling the processor to assign a second score to the business organization based on the past performance of the business organization; and
third means for enabling the processor to assign a third score to the company by correlating said first score to said second score, wherein said third score indicates a projected investment value of the business organization.

2. The computer program product of claim 1, further comprising:
fourth means for enabling the processor to store said third score in a database.

3. The computer program product of claim 2, further comprising:
fifth means for enabling the processor to provide the contents of said database to a user via a data network.

4. The computer program product of claim 1, wherein said first means comprises means for enabling the processor to assign a score to the business organization based on chief executive officer compensation.

5. The computer program product of claim 1, wherein said first means comprises means for enabling the processor to assign a score to the business organization based on outside director shareholdings.

6. The computer program product of claim 1, wherein said first means comprises means for enabling the processor to assign a score to the business organization based on merger and acquisition decisions.

7. The computer program product of claim 1, wherein said first means comprises means for enabling the processor to assign a score to the business organization based on accounting and audit practices.

8. The computer program product of claim 1, wherein said second means comprises means for enabling the processor to assign a score to the business organization based on the difference between a return on investment in the business organization and an industry average return on investment.

9. A computer program product comprising a computer useable medium having computer program logic recorded thereon for enabling a processor in a computer system to project the future investment value of a business organization, said computer program logic comprising:
first means for enabling the processor to assign a first score to the business organization, wherein said first score is based on chief executive officer compensation, outside director shareholdings, merger and acquisition decisions, and accounting and audit practices;
second means for enabling the processor to assign a second score to the business organization based on past performance of the business organization; and
third means for enabling the processor to assign a third score to the company by correlating said first score to said second score, wherein said third score indicates a projected investment value of the business organization.

10. A computer program product comprising a computer useable medium having computer program logic recorded thereon for enabling a processor in a computer system to project the future investment value of a business organization, said computer program logic comprising:
first means for enabling the processor to assign a first score to the business organization, wherein said first score is based on chief executive officer compensation and outside director shareholdings;
second means for enabling the processor to assign a second score to the business organization based on past performance of the business organization; and
third means for enabling the processor to assign a third score to the company by correlating said first score to said second score, wherein said third score indicates a projected investment value of the business organization.

11. A method for projecting the future investment value of a business organization, comprising:
assigning a first score to the business organization based on corporate governance of the business organization;
assigning a second score to the business organization based on past performance of the business organization; and
assigning a third score to the company by correlating said first score to said second score, wherein said third score indicates a projected investment value of the business organization.

12. The method of claim 11, further comprising storing said third score in a database.

13. The method of claim 12, further comprising providing the contents of said database to a user via a data network.

14. The method of claim 12, wherein said database is stored on a computer useable medium, and wherein said method further comprises providing said computer useable medium to a user.

15. The method of claim 11, wherein said step of assigning a first score comprises assigning a score to the business organization based on chief executive officer compensation.

16. The method of claim 11, wherein said step of assigning a first score comprises assigning a score to the business organization based on outside director shareholdings.

17. The method of claim 11, wherein said step of assigning a first score comprises assigning a score to the business organization based on merger and acquisition decisions.

18. The method of claim 11, wherein said step of assigning a first score comprises assigning a score to the business organization based on accounting and audit practices.

19. The method of claim 11, wherein said step of assigning a second score comprises assigning a score based on the difference between a return on investment in the business organization and an industry average return on investment.

20. The method of claim 11, further comprising collecting data about the business organization prior to any of the assigning steps.

21. A method for projecting the future investment value of a business organization, comprising:
collecting corporate governance data and past performance data about the business organization;
assigning a first score to the business organization based on said corporate governance data;
assigning a second score to the business organization based on said past performance data;
assigning a third score to the company by correlating said first score to said second score, wherein said third score indicates a projected investment value of the business organization; and
providing said third score to a user.

22. A method for projecting the future investment value of a business organization, comprising:
assigning a first score to the business organization, wherein said first score is based on chief executive officer compensation, outside director shareholdings, merger and acquisition decisions, and accounting and audit practices;
assigning a second score to the business organization based on past performance of the business organization; and
assigning a third score to the company by correlating said first score to said second score, wherein said third score indicates a projected investment value of the business organization.

23. A method for projecting the future investment value of a business organization, comprising:
assigning a first score to the business organization, wherein said first score is based on chief executive officer compensation and outside director shareholdings;
assigning a second score to the business organization based on past performance of the business organization; and
assigning a third score to the company by correlating said first score to said second score, wherein said third score indicates a projected investment value of the business organization.
